(19) United States
(12) Patent Application Publication
(10) Pub. No.: US 2012/0306157 A1
(43) Pub. Date: Dec. 6, 2012

(54) Liquid Magnetic Seals in Wankel-Type Rotary Engines

(75) Inventor: Christopher Michael Joyce, Arlington, VA (US)

(73) Assignee: Christopher Michael Joyce, Arlington, VA (US)

(21) Appl. No.: 13/151,533

(22) Filed: Jun. 2, 2011

(51) Int. Cl. F16J 15/43

(52) U.S. Cl. 277/410

(57) ABSTRACT

This invention proposes a new way of sealing the working chambers in Wankel-type rotary engines, by using ferrofluids and magnets in place of typical metal seals. The use of ferrofluids will allow for not only a better seal, but one that is easier to maintain.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING CD APPENDIX

N/A

### BACKGROUND OF THE INVENTION

The Wankel Rotary Engine was developed by Dr. Felix Wankel as an alternative to the standard 4-stroke internal combustion engine.

Historically, sealing systems in Wankel type rotary engines (an alternative to the standard piston engine) are incredibly complex, and are the biggest constraining factor on the useful lifespan of the engine.

Standard sealing systems require a metal-to-metal interface (with a thin oil film) on the inside of the engine chamber—which results in scraping of both the inner wall of the engine compartment and the tips of the rotor, as machining is perfect for neither component. This metal-to-metal interface means that most seals wear out rapidly, decreasing engine efficiency. To smooth out the seals and chamber enough to minimize this corrosion often involves costly and time-consuming plating with metals that tend to give smoother finishes—like chrome.

Sealing systems that can be expected to last for equivalent times to a piston engine have been developed, but they are incredibly complex. This results in both a longer development cycle and more complex manufacturing processes—both of which increase cost of getting a Wankel engine to market.

### BRIEF SUMMARY OF THE INVENTION

Using ferrofluids or MR fluids (generalized as ferrofluids from here on) in place of these complex, multi-part sealing systems provides a far simpler (and therefore cheaper) alternative.

The system I am proposing would involve placing magnets close to each tip of a rotor in a Wankel-type engine. These magnets would then attract the ferrofluid to cluster around the tip of the rotor, pressing against the wall of the epitrochoidal chamber. This would provide a sealing barrier that would conform to irregularities in the surface of the chamber, providing a better seal than could be achieved with metal-to-metal contact.

### BRIEF DESCRIPTION OF THE SEVERAL VIEWS OF THE DRAWING

FIG. 1 shows the location of the apex seals on a classic 3-surface Wankel-type rotary engine.

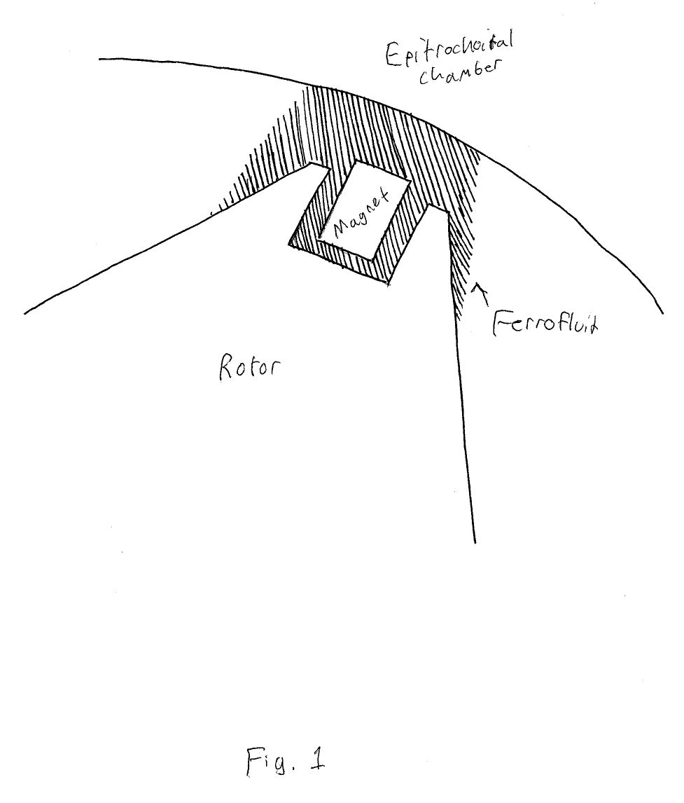

FIG. 2 shows an apex seal in further detail—letter A represents the ferrofluid, in its expected locations around the seal. Letter B represents a long magnetic strip that will be used to keep the ferrofluid at the rotor tips. Letter C represents the bulk of the rotor, and letter D represents the housing. Letters A and B represent only one possible configuration covered by this patent—there are multiple places to put the magnet (the fluid's location responding to said location), all of which are claimed by this inventor. FIG. 2 is merely an illustration of how it could be done, not the only way to do it.

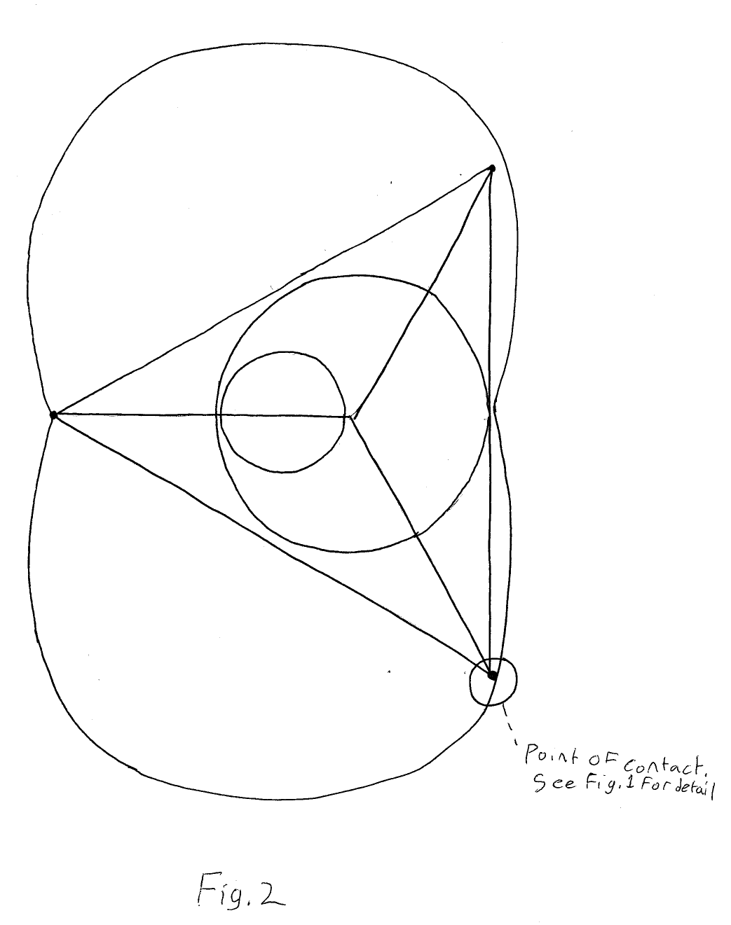

### DETAILED DESCRIPTION OF THE INVENTION

Ferrofluids are colloidal fluids with small metallic particles (often iron-based, hence the ‘ferro’) suspended within them. When a magnetic field is applied to a ferrofluid, the particles align, causing the fluid to stiffen. The degree to which they stiffen is heavily dependent on the particulars of the fluid and the strength of the magnetic field, however, one can create quite durable ferrofluid barriers.

Ferrofluids, when a magnetic field is applied, therefore behave in some ways like solids and in some ways like liquids. They behave like solids in that they can counteract gravity, given a strong enough magnetic field. They behave like liquids in that they don't have a single defined shape—they will change shape as necessary to fill the space that exists.

This means that one could form an excellent, durable seal with ferrofluids and magnets. The magnetic field would cause the ferrofluids to provide a barrier between the sealing surfaces, regardless of direction, while the liquid properties would mean that the fluid would conform very closely to the boundaries of the chamber in which it resides—close enough to make manufacturing flaws irrelevant.

Using ferrofluids for seals is not a new idea—they are often used to seal hard drives, for example. They have even been used to aid seals in piston engines—however, the inventor, despite much searching, has not found any documented attempt to use ferrofluids to seal a rotary engine.

This seal would also be easily reparable—unlike current Wankel engines, which must be completely rebuilt when the seals wear out. In all engines, fluids lose effectiveness over times, and must be replaced—be it oil, brake fluid, or what have you. This is such a common—and old—problem that it has been solved several times, in several different ways. It would be trivial to develop a way to cycle ferrofluids through the engine, to keep the engine running efficiently, especially as compared to a complete rebuild of the engine.

1. Using ferrofluids as a component in a sealing mechanism wankel-type rotary engine.
